(19) United States
(12) Patent Application Publication
(10) Pub. No.: US 2021/0027231 A1
(43) Pub. Date: Jan. 28, 2021

(54) SYSTEM FOR COMPUTATION ENTERPRISE PERFORMANCE METRICS

(71) Applicant: Microsoft Technology Licensing, LLC, Redmond, WA (US)

(72) Inventors: Brian Scott Ruble, Bellevue, WA (US); Daniel Judah Popper, Silver Spring, MD (US); Darinder Pandher, Kent, WA (US); Anjaneya Sudarshan Malpani, Bellevue, WA (US); Maja Vladan Milosavljevic, Lexington, MA (US); Ankit Tandon, Bellevue, WA (US); Andrew Jin Kim, Kirkland, WA (US)

(21) Appl. No.: 16/523,164

(22) Filed: Jul. 26, 2019

(51) Int. Cl. G06Q 10/06; G06K 9/62; G06F 16/904

(52) U.S. Cl. CPC G06Q 10/06393; G06F 16/904; G06K 9/6267

(57) ABSTRACT

A system and method for determining enterprise metrics of an enterprise application is described. The system identifies a plurality of users of an enterprise. The system accesses enterprise usage data of an enterprise application from user accounts of an enterprise. The system accesses a profile of the enterprise and computes a first plurality of metrics based on the enterprise usage data and the profile of the enterprise. The system computes a first plurality of indexes based on the first plurality of metrics. The system then identities a plurality of benchmark indexes based on the profile of the enterprise. A graphical user interface indicating the first plurality of indexes relative to the plurality of benchmark indexes is generated.

### BACKGROUND

The subject matter disclosed herein generally relates to a special-purpose machine that computes enterprise performance metrics, including computerized variants of such special-purpose machines and improvements to such variants. Specifically, the present disclosure addresses systems and methods for computing enterprise performance benchmarks and indexes and identifying outliers based on the indexes.

Measuring a performance of an enterprise can be difficult to determine given the millions of data point entries and the lack of context of computed metrics. Furthermore, the effectiveness and accuracy of human-driven analysis of large sets of data is increasingly low compared to machine-driven analysis. For example, if an organization needs a time sensitive analysis of a data set that has millions of entries across hundreds of variables, no human could perform such an analysis by hand or mentally. Furthermore, any such analysis may be out-of-date almost immediately, should an update be required.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 is a block diagram illustrating an enterprise performance engine in accordance with one example embodiment.

FIG. 3 is a block diagram illustrating a benchmark indices computation module in accordance with one embodiment.

FIG. 4 is a flow diagram illustrating a method for computing performance benchmark metrics in accordance with one example embodiment.

FIG. 5 is a flow diagram illustrating a method for computing enterprise indexes in accordance with one example embodiment.

FIG. 6 is a flow diagram illustrating a method for generating a recommendation in accordance with one example embodiment.

FIG. 7 is a flow diagram illustrating a method for calling an application function in accordance with one example embodiment.

FIG. 8 illustrates a routine in accordance with one embodiment.

FIG. 9 illustrates an example of a graph illustrating a knowledge worker productivity in accordance with one example embodiment.

FIG. 10 illustrates an example of a graphical user interface of a meeting culture index in accordance with one example embodiment.

FIG. 11 illustrates an example of a graphical user interface of a balance index in accordance with one example embodiment.

FIG. 12 illustrates an example of a graphical user interface of a collaboration index in accordance with one example embodiment.

FIG. 13 illustrates an example of a graphical user interface of a complexity index in accordance with one example embodiment.

FIG. 14 illustrates an example of a graph of an operating income graph in accordance with one example embodiment.

FIG. 15 illustrates an example of a graph of a revenue income graph in accordance with one example embodiment.

FIG. 16 illustrates an example of a graph of a working performance graph in accordance with one example embodiment.

FIG. 17 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The present application describes a method for computing a performance of an enterprise. An enterprise represents organizations or groups of users associated with an organization. In particular, the system provides algorithms to calculate the performance of an enterprise relative to the performance of its peers. The system determines the peer enterprises based on a profile of the enterprise. The system further renders a graph that displays different aspects of the performance of the enterprise relative to its peers. The system computes the performance based on metrics corresponding to the enterprise. The system accesses data points from an enterprise application operated by the enterprise. For example, devices associated with the enterprise communicate with a remote server hosting the enterprise application. In other examples, the devices associated with the enterprise include a local copy of the enterprise application and communicate user activities of local copy to the remote server. The data points include user activities associated with the enterprise application of the enterprise. Examples of data points include dates and times of users operating the enterprise application, types of documents being accessed or shared by users of the enterprise application, users calendar data from the enterprise application, communication data between users of the enterprise application, and enterprise organization data. Examples of enterprise applications include email applications, document editing applications, document sharing applications, and other types of applications used by enterprises.

The system generates a graphical user interface that includes graphs and illustrates the performance indices of the enterprise relative to its peers. Examples of performance indices include knowledge worker productivity index, meeting culture index, balance index, collaboration index, and complexity index.

In one example embodiment, the system accesses enterprise usage data of an enterprise application from user accounts of an enterprise. The system accesses a profile of the enterprise and computes a first plurality of metrics based on the enterprise usage data and the profile of the enterprise. The system computes a first plurality of indexes based on the first plurality of metrics. The system then identifies a plurality of benchmark indexes based on the profile of the enterprise. A graphical user interface indicating the first plurality of indexes relative to the plurality of benchmark indexes is generated.

As a result, one or more of the methodologies described herein facilitate solving the technical problem of determining enterprise metrics of an enterprise application. As such, one or more of the methodologies described herein may obviate a need for certain efforts or computing resources. Examples of such computing resources include processor cycles, network traffic, memory usage, data storage capacity, power consumption, network bandwidth, and cooling capacity.

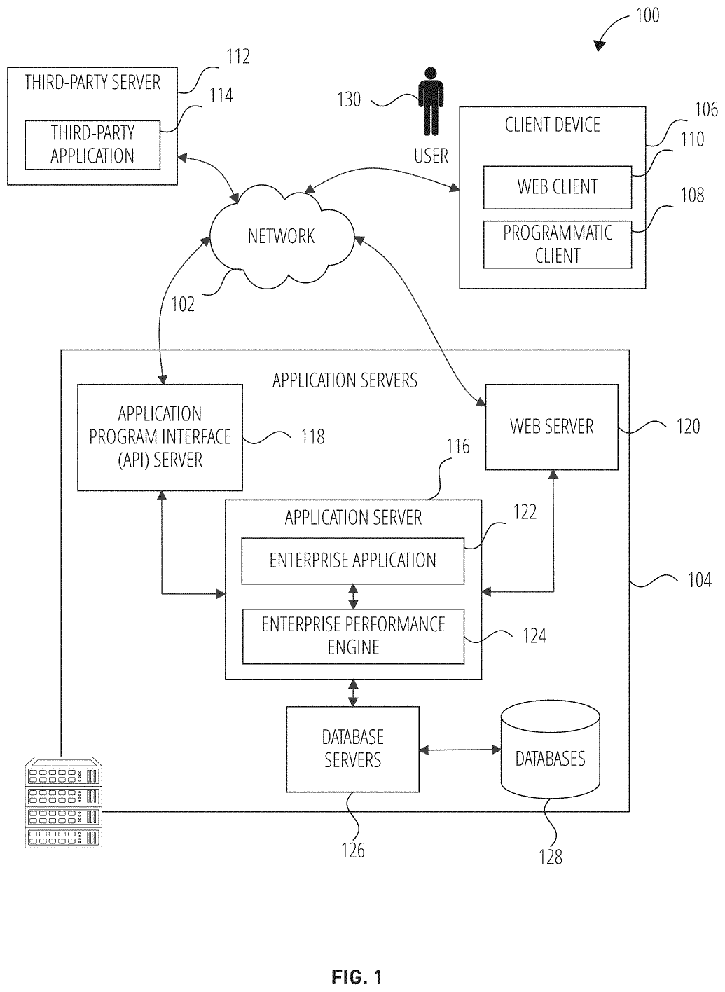

FIG. 1 is a diagrammatic representation of a network environment in which some example embodiments of the present disclosure may be implemented or deployed. One or more application servers 104 provide server-side functionality via a network 102 to a networked user device, in the form of a client device 106. A user 130 operates the client device 106. The client device 106 includes a web client 110 (e.g., a browser), a programmatic client 108 (e.g., an email/calendar application such as Microsoft Outlook (TM), an instant message application, a document writing application, a shared document storage application) that is hosted and executed on the client device 106. In one example embodiment, the programmatic client 108 logs interaction data from the web client 110 and the programmatic client 108 with the enterprise application 122. In another example embodiment, the enterprise application 122 logs interaction data between the web client 110, the programmatic client 108, and the enterprise application 122. The interaction data may include for example, communication logs of communications (e.g., emails) between users of an enterprise or communications between users of the enterprise and outside users of the enterprise. Other examples of interaction data include and are not limited to email communications, meeting communications, instant messages, shared document comments, and any communication with a recipient (e.g., a user from or outside the enterprise).

An Application Program Interface (API) server 118 and a web server 120 provide respective programmatic and web interfaces to application servers 104. A specific application server 116 hosts the enterprise application 122 and an enterprise performance engine 124. Both enterprise application 122 and enterprise performance engine 124 include components, modules and/or applications.

The enterprise application 122 may include collaborative applications (e.g., a server side email/calendar enterprise application, a server side instant message enterprise application, a document writing enterprise application, a shared document storage enterprise application) that enable users of an enterprise to collaborate and share document, messages, and other data (e.g., meeting information, common projects) with each other. For example, the user 130 at the client device 106 may access the enterprise application 122 to edit documents that are shared with other users of the same enterprise. In another example, the client device 106 accesses the enterprise application 122 to retrieve or send messages or emails to and from other peer users of the enterprise. Other examples of enterprise application 122 includes enterprise systems, content management systems, and knowledge management systems.

In one example embodiment, the enterprise performance engine 124 communicates with the enterprise application 122 and accesses interaction data from users of the enterprise application 122. In another example embodiment, the enterprise performance engine 124 communicates with the programmatic client 108 and accesses interaction data from the user 130 with other users of the enterprise. In one example, the web client 110 communicates with the enterprise performance engine 124 and enterprise application 122 via the programmatic interface provided by the Application Program Interface (API) server 118.

The enterprise performance engine 124 computes enterprise performance indexes based on metrics collected from the interaction data collected by the enterprise application 122, the item web client 110, or the programmatic client 108. The metrics may be associated with a profile of the enterprise (e.g., size of the enterprise, revenues, locations, etc.). In another example, the enterprise performance engine 124 computes enterprise benchmarks based on metrics based on interaction data between other enterprises and the enterprise application 122. The enterprise performance engine 124 enterprise benchmarks are associated with corresponding enterprise profiles. For example, a benchmark index may depend on the size of the enterprise. The enterprise performance engine 124 retrieves benchmarks of peer enterprises based on the profile of the enterprise (e.g., enterprises with similar sizes).

The enterprise performance engine 124 generates a graphical user interface (GUI) that presents the indexes of the enterprise relative to the indexes of peer enterprises. The GUI includes graphs that illustrate the relationship between the indexes of the enterprise and the indexes of the peer enterprises. In another example embodiment, the GUI indicates a recommendation based on the enterprise performance indexes. The GUI includes a user interactive region that includes the recommendation.

In another example embodiment, the enterprise performance engine 124 detects a selection of a recommended action from the recommendation and generates a dialog box pre-populated with information based on the recommended action (e.g., pre-filled with parameters of a feature of the enterprise application 122). The user 130 only has to click on one button to configure the programmatic client 108 with the new parameters. For example, the pre-filled parameters configure the programmatic client 108 to prevent from retrieving or sending emails between 10 pm and 6 am on weekdays and all day on weekends. Such configuration results in a change of the performance index of the enterprise.

The application server 116 is shown to be communicatively coupled to database servers 126 that facilitates access to an information storage repository or databases 128. In an example embodiment, the databases 128 includes storage devices that store information to be processed by the enterprise application 122 and the enterprise performance engine 124.

Additionally, a third-party application 114 may, for example, store another part of the enterprise application 122, or include a cloud storage system. For example, the third-party application 114 stores other metrics related to the enterprises. The metrics may include size of the enterprises, industry classification, and updated revenue. The third-party application 114 executing on a third-party server 112, is shown as having programmatic access to the application server 116 via the programmatic interface provided by the Application Program Interface (API) server 118. For example, the third-party application 114, using information retrieved from the application server 116, may supports one or more features or functions on a website hosted by the third party.

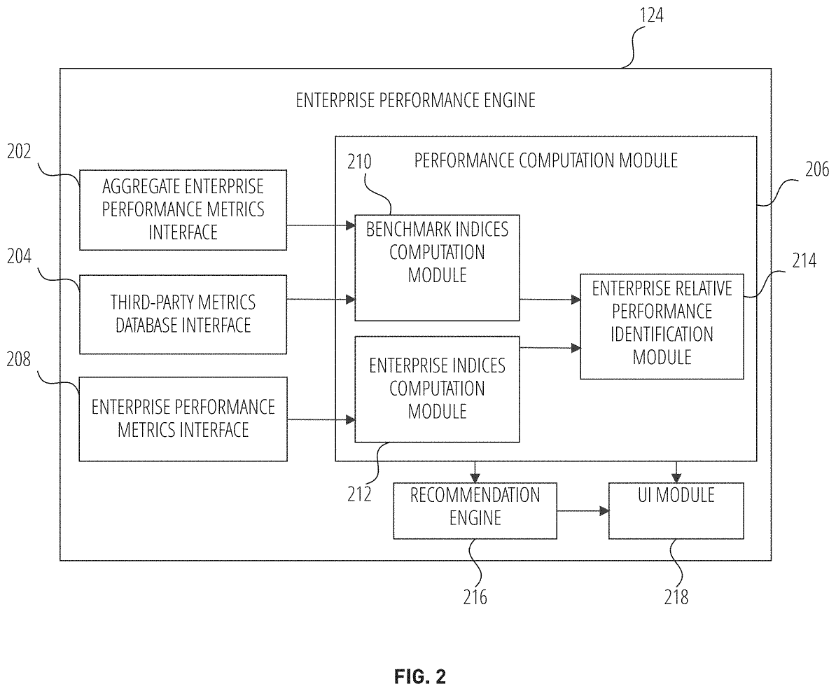

FIG. 2 is a block diagram illustrating an enterprise performance engine in accordance with one example embodiment. The enterprise performance engine 124 comprises an aggregate enterprise performance metrics interface 202, a third-party metrics database interface 204, a performance computation module 206, an enterprise performance metrics interface 208, a benchmark indices computation module 210, an enterprise indices computation module 212, an enterprise relative performance identification module 214, a recommendation engine 216, and a UI module 218.

The aggregate enterprise performance metrics interface 202 communicates with devices of all enterprises having access to the enterprise application 122. In one example embodiment, the aggregate enterprise performance metrics interface 202 accesses user interaction data from devices of all enterprises having access to the enterprise application 122. The user interaction data includes any interaction between any user account of the enterprise with the enterprise application 122.

Examples of metrics obtained by the aggregate enterprise performance metrics interface 202 include: Multi-Tasking Hours; Meeting Hours Adjusted-Meeting Hours; Work Week Span; After Hours Work (collaboration hours); % of employees who work greater than 50 hours per week and 5 hours after hours; Top Country 1 Name; Top Country 1 User count; Top Country 2 Name; Top Country 2 User Count; Top Country 3 Name; Top Country 3 User Count; Top Country 4 Name; Top Country 4 User Count; Top Country 5 Name; Top Country 5 User Count; Average Number of External Domains Per Person; Percentage of Collaboration External; Percentage of Collaboration Internal; Top Domain 1 Name; Top Domain 1 Interaction Count; Top Domain 2 Name; Top Domain 2 Interaction Count; Top Domain 3 Name; Top Domain 3 Interaction Count; Top Domain 4 Name; Top Domain 4 Interaction Count; Conflicting Hours; Large Meeting Hours; Long Meeting Hours; % of employees who work greater than 40 hours per week; Average Number of Geographies Per Person; % of employees that interact more than 1 hour externally; Ratio of external to internal collaboration; Number of active mailboxes.

The third-party metrics database interface 204 communicates with a third-party database (e.g., third-party server 112) that stores periodically updated profiles of the enterprises (e.g., enterprise size, revenue, industry, etc.). In one example embodiment, the third-party metrics database interface 204 retrieves the periodically updated profiles data from the third-party server 112.

Examples of metrics obtained by the third-party metrics database interface 204 include revenue, industry classification, and size classification. By knowing the metrics, industry classification and size classification, the benchmark indices computation module 210 can generate benchmarks by grouping the companies based on the combinations of industry classification and size classification. If there is an industry and size combination that does not meet the minimum group size, then no benchmark is generated for that combination. The output is stored in a data storage.

The enterprise performance metrics interface 208 retrieves user interaction data for the enterprise (e.g., a specific enterprise). For example, the enterprise performance metrics interface 208 retrieves the user interaction data from the enterprise application 122 or the client device 106 of the enterprise.

The performance computation module 206 computes benchmark indices and enterprise indices. The performance computation module 206 comprises benchmark indices computation module 210, enterprise indices computation module 212, and enterprise relative performance identification module 214. The benchmark indices computation module 210 retrieves aggregate interaction data from aggregate enterprise performance metrics interface 202 and enterprise profiles from the third-party metrics database interface 204. In one example embodiment, the benchmark indices computation module 210 computes benchmark indices based on the aggregate interaction data.

The enterprise indices computation module 212 computes performance indices (for a selected enterprise) based on the user interaction data from the enterprise. The enterprise relative performance identification module 214 generates a graph that indicates the performance indices of the enterprise relative to its peers as determined based on the profile of the enterprise.

In one example, the enterprise indices computation module 212 assigns the industry and size classification to the metrics of a specific enterprise. The enterprise indices computation module 212 measures workplace productivity by the spreads of the metrics in the same industry and size bucket combination. The benchmark indices computation module 210 determines the industry average for the scores.

The recommendation engine 216 generates a recommendation based on a performance index of an enterprise relative to a benchmark index of its peers. For example, if a performance index is below a benchmark index, the recommendation engine 216 provides one or more recommendations on how to increase the performance index. In one example embodiment, the recommendation engine 216 accesses a lookup table based on the index value and identifies a recommended action based on an index margin threshold between the performance index and the benchmark index. The lookup table may specify different types of actions based on the value of the index margin threshold. For example, the different types of actions may vary based on the difference between the performance index and the benchmark index.

In one example embodiment, the recommendation engine 216 may suggest that users of the enterprise refrain from emailing between midnight and 6 am. The recommendation engine 216 generates a function call to an application (e.g., email application) corresponding to the suggestion selected by the user. For example, if the user accepts the email parameters suggested by the recommendation engine 216, the recommendation engine 216 launches the email application at the client device of the user and configures the email application with the suggested parameters.

The UI module 218 generates a graphical user interface that indicates the performance index, the benchmark index for the enterprise, and the recommendation from the recommendation engine 216.

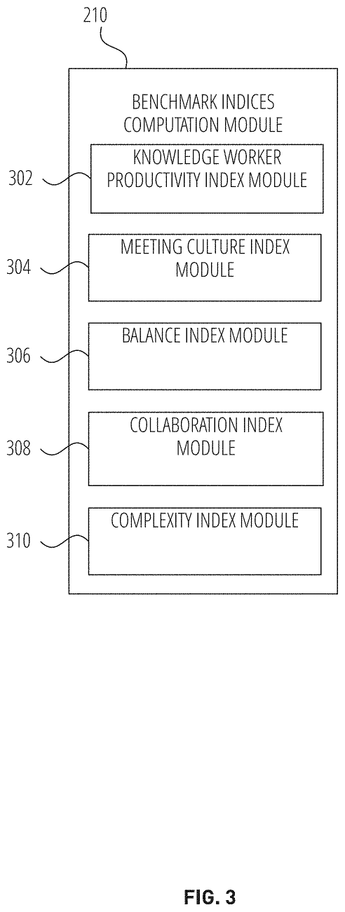

FIG. 3 is a block diagram illustrating a benchmark indices computation module in accordance with one embodiment. The benchmark indices computation module 210 comprises a knowledge worker productivity index module 302, a meeting culture index module 304, a balance index module 306, a collaboration index module 308, and a complexity index module 310. The modules illustrated in FIG. 3 are examples. The benchmark indices computation module 210 are not limited to the modules described in FIG. 3.

The knowledge worker productivity index module 302 computes a productivity index of users of an enterprise. In one example embodiment, knowledge worker productivity is calculated by dividing a company's revenue from the previous fiscal year (in US Dollars) by the total number of their active employees. An active employee is defined as one who sent at least one email in the last week. For determining the industry benchmark (e.g., average) for Knowledge Worker Productivity, the knowledge worker productivity index module 302 randomly sample 95% of all companies from all enterprises having access to the enterprise application 122 and then segment them by standard industries and company size. From this, the knowledge worker productivity index module 302 calculates an average for each industry and size pairing. Examples of industries and company sizes include:

Standard Industries: Banking, Insurance, Business, Professional Services, High Tech, Computer, Telecommunications, Entertainment, Construction, Real Estate, Healthcare, Pharmaceuticals, Education, Consumer Services, Retail, Electronics, Rental, Repair, Wholesale

Company Sizes: SMB (Small Business): 1-250 employees; SMS&P (Medium/Small Business): 250-500 employees; SMS&P (Medium/Large Business): 500-1000 employees; Corporate Enterprise (EPG): 1000-5000 employees; Major Large Enterprise (MLE): 5000+ employees

The knowledge worker productivity index module 302 generates a graph analysis. The x-axis measure for the Working Smarter vs. Working Harder visualization is generated by dividing Knowledge Worker Productivity by the company's average workweek span. The workweek span metric is defined as the time between the person's first sent email or meeting attended and the last email or meeting in a day (counted Monday through Friday, with a minimum of four hours and a maximum of 16 hours per day.)

The meeting culture index module 304 computes a meeting culture index for an enterprise by adding the meeting quality score to the meeting quantity score and normalizing the resultant score to between 0 and 100. A meeting quantity score is meeting hours per user per week for the organization. The meeting culture index module 304 filters any meeting with longer than 8 hours in duration or with greater than 250 attendees are excluded. The meeting culture index module 304 computes the Meeting quality score by adding 0.25*A+0.25*B+0.25*C+0.25*D where A=the normalized multi-tasking meeting hours sub-score, B=the normalized percentage of conflicting hours sub-score, C=the normalized time spent in long meetings sub-score, and D=the normalized time spent in large meetings sub-score.

Multi-tasking meeting hours is defined as the number of meeting hours where the person sent two or more emails per meeting hour and/or two or more emails sent per meeting for meetings less than one hour. Percentage of conflicting meetings is calculated by finding the proportion of meetings on a user's calendar that overlap in time with any other meeting on their calendar. Long meetings are defined as meetings that are longer than 4 hours. Large meetings are defined as meetings where the number of attendees is greater than 18. The meeting culture index module 304 normalizes the meeting culture index by applying the following transformation to the underlying metric: [Metric Value−Minimum Value]/[Maximum Value−Minimum Value]*100. For determining the industry average, the meeting culture index module 304 randomly samples 95% of all companies from all enterprises having access to the enterprise application 122 and then segments them by standard industries and company size. From this, the meeting culture index module 304 calculates an average for each industry and size pairing.

The balance index module 306 computes a balance index. In one example embodiment, the balance index module 306 determines the balance index by adding 0.5*A to 0.5*B where A=the normalized Workweek span sub-score, and B=the normalized after-hours collaboration sub-score. A workweek span metric is defined as the time between the person's first sent email or meeting attended and the last email or meeting in a day (counted Monday through Friday, with a minimum of four hours and a maximum of 16 hours per day.) The after-hours collaboration metric is defined as the number of hours the person spent in meetings and on email outside of working hours. The creation of the normalized sub-score involves applying the following transformation to the underlying metric: [Metric Value−Minimum Value]/[Maximum Value−Minimum Value]*100. For determining the industry average, the balance index module 306 randomly samples 95% of all enterprises having access to the enterprise application 122 and then segments them by standard industries and company size. From this, the balance index module 306 calculates an average for each industry and size pairing.

The collaboration index module 308 calculates a collaboration index by adding 0.5*A to 0.5*B where A=the normalized percent of employees that interact with external domains for more than 1-hour sub-score, and B=the normalized ratio of external to internal collaborators sub-score. The percent of employees that interact with external domains is calculated by finding the percentage of total employees that send at least one email with an external domain where an external domain is a domain that the organization does not own. The ratio of external to internal collaborators metric is calculated by creating a ratio of external to internal emails sent in the organization. The creation of the normalized sub-score involves applying the following transformation to the underlying metric: [Metric Value−Minimum Value]/[Maximum Value−Minimum Value]*100. For determining the industry average, the collaboration index module 308 randomly sample 95% of all enterprises having access to the enterprise application 122 and then segment them by standard industries and company size. From this, the collaboration index module 308 calculates an average for each industry and size pairing.

The complexity index module 310 calculates an organization complexity index by adding 0.5*A to 0.5*B where A=the number of geographies per employee sub-score, and B=the number of external domains per employee sub-score. The number of geographies per employee is calculated by dividing the number of distinct geographies that an organization has employees at by the employee count. The number of external domains per employee is calculated by dividing the number of external domains the organization sends emails to by employee count. The creation of the normalized sub-score involves applying the following transformation to the underlying metric: [Metric Value−Minimum Value]/[Maximum Value−Minimum Value]*100. For determining the industry average, the complexity index module 310 randomly sample 95% of all enterprises having access to the enterprise application 122 and then segment them by standard industries and company size. From this, the complexity index module 310 calculates an average for each industry and size pairing.

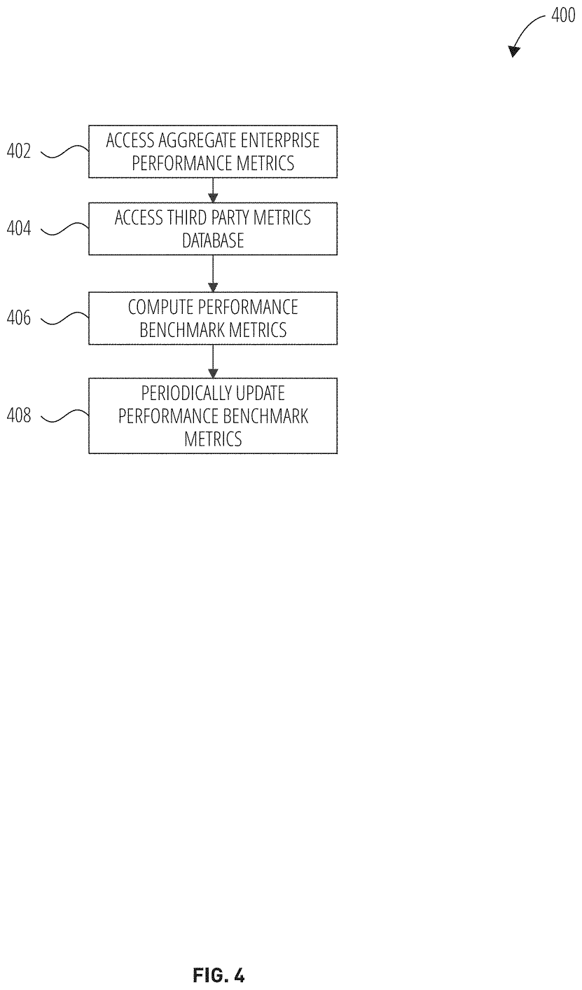

FIG. 4 is a flow diagram illustrating a method 400 for computing collaboration strength metrics in accordance with one example embodiment. Operations in the method 400 may be performed by the enterprise performance engine 124, using components (e.g., modules, engines) described above with respect to FIG. 2. Accordingly, the method 400 is described by way of example with reference to the enterprise performance engine 124. However, it shall be appreciated that at least some of the operations of the method 400 may be deployed on various other hardware configurations or be performed by similar components residing elsewhere. For example, some of the operations may be performed at the client device 106.

At block 402, the benchmark indices computation module 210 accesses aggregate enterprise performance metrics (e.g., enterprise application usage data). At block 404, the benchmark indices computation module 210 accesses a third-party metrics data (e.g., financial data, enterprise profile) from a third-party metrics database. At block 406, the benchmark indices computation module 210 computes performance benchmark metrics by industry and size based on the aggregate enterprise performance metrics and the third-party metrics data. At block 408, the benchmark indices computation module 210 periodically updates the performance benchmarks based on updated third party metrics data and updated aggregate enterprise performance metrics.

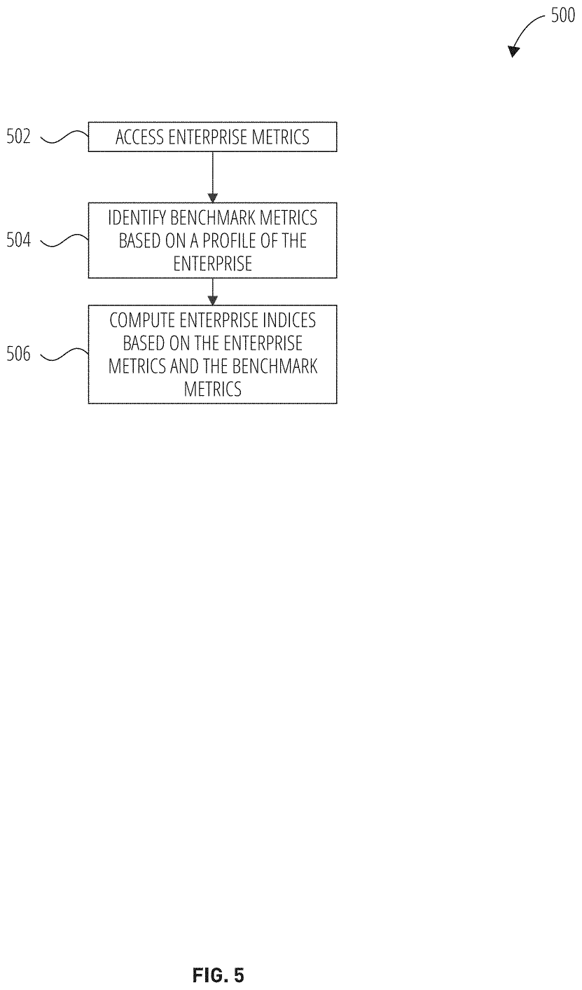

FIG. 5 is a flow diagram illustrating a method 500 for computing collaboration strength metrics in accordance with one example embodiment. Operations in the method 500 may be performed by the enterprise performance engine 124, using components (e.g., modules, engines) described above with respect to FIG. 2. Accordingly, the method 500 is described by way of example with reference to the enterprise performance engine 124. However, it shall be appreciated that at least some of the operations of the method 500 may be deployed on various other hardware configurations or be performed by similar components residing elsewhere. For example, some of the operations may be performed at the client device 106.

At block 502, the enterprise indices computation module 212 accesses enterprise metrics of an enterprise. At block 504, the enterprise indices computation module 212 identifies benchmark metrics based on a profile of the enterprise. At block 506, the enterprise relative performance identification module 214 computes enterprise indices based on the enterprise metrics and the benchmark metrics.

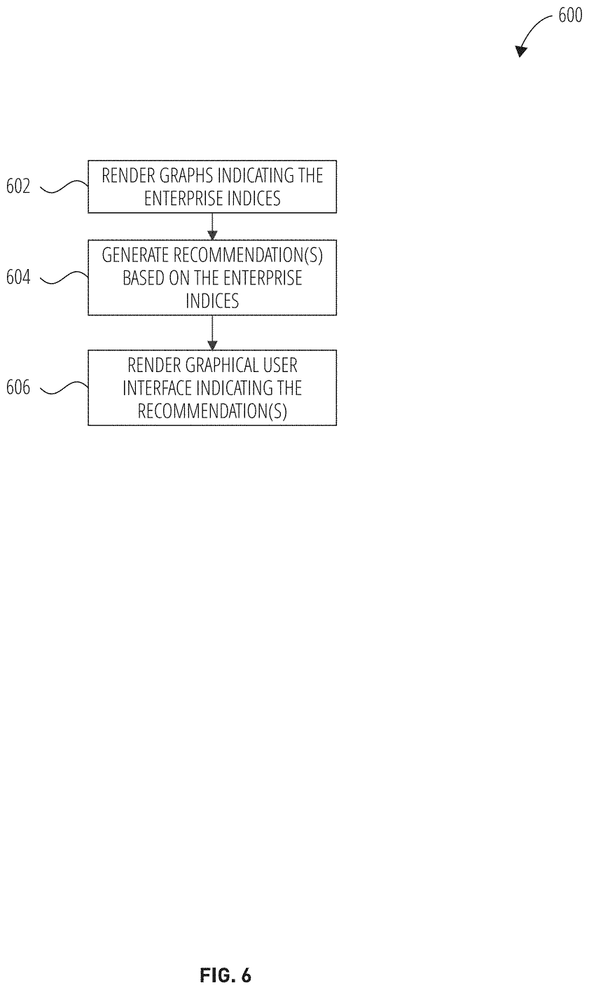

FIG. 6 is a flow diagram illustrating a method 600 for computing collaboration strength metrics in accordance with one example embodiment. Operations in the method 600 may be performed by the enterprise performance engine 124, using components (e.g., modules, engines) described above with respect to FIG. 2. Accordingly, the method 600 is described by way of example with reference to the enterprise performance engine 124. However, it shall be appreciated that at least some of the operations of the method 600 may be deployed on various other hardware configurations or be performed by similar components residing elsewhere. For example, some of the operations may be performed at the client device 106.

At block 602, the UI module 218 renders graphs indicating the enterprise indices. For example, the UI module 218 generates a first graph based on the index computed by the knowledge worker productivity index module 302, a second graph based on the index computed by the meeting culture index module 304, a third graph based on the index computed by the balance index module 306, a fourth graph based on the index computed by the collaboration index module 308, and a fifth graph based on the index computed by the complexity index module 310.

At block 604, the recommendation engine 216 generates recommendation(s) based on the enterprise indices. In one example embodiment, the recommendation engine 216 generates a first recommendation based on the first graph, a second recommendation based on the second graph, a third recommendation based on the third graph, a fourth recommendation based on the fourth graph, and a fifth recommendation based on the fifth graph. In another example, the recommendation engine 216 generates an overall recommendation based on the combination of the first, second, third, fourth, and fifth graphs.

At block 606, the UI module 218 renders a graphical user interface indicating the recommendation(s).

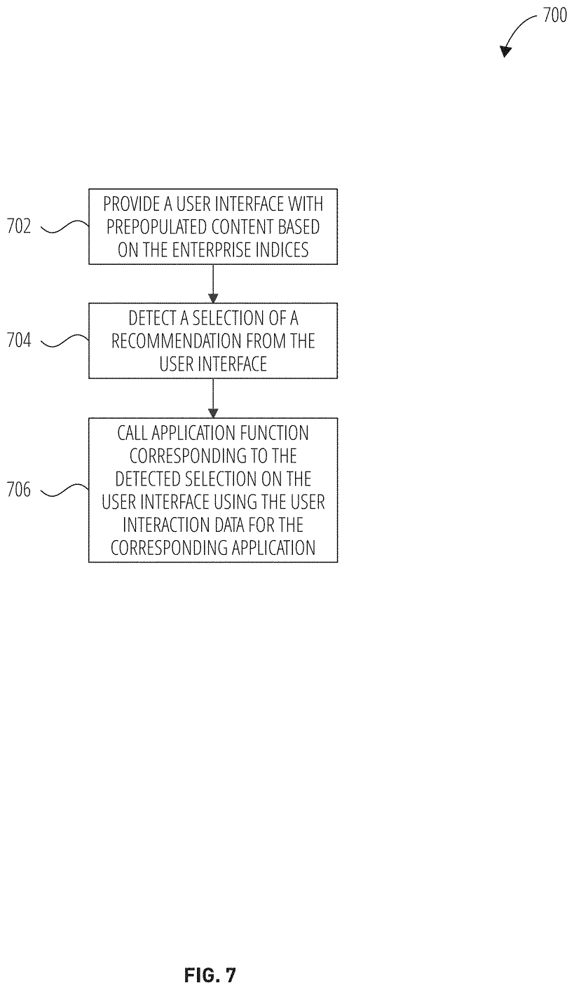

FIG. 7 is a flow diagram illustrating a method 700 for calling an application function in accordance with one example embodiment. Operations in the method 700 may be performed by the enterprise performance engine 124, using components (e.g., modules, engines) described above with respect to FIG. 2. Accordingly, the method 700 is described by way of example with reference to the enterprise performance engine 124. However, it shall be appreciated that at least some of the operations of the method 700 may be deployed on various other hardware configurations or be performed by similar components residing elsewhere. For example, some of the operations may be performed at the client device 106.

At block 702, the recommendation engine 216 generates a recommendation with prepopulated content/configuration/parameters based on the enterprise indices. The UI module 218 generates a graphical user interface based on the recommendation. At block 704, the UI module 218 detects a selection of the recommendation from the graphical user interface. At block 706, the UI module 218 calls an application function corresponding to the detected selection on the user interface using the user interaction data for the corresponding application (e.g., email application, calendar application).

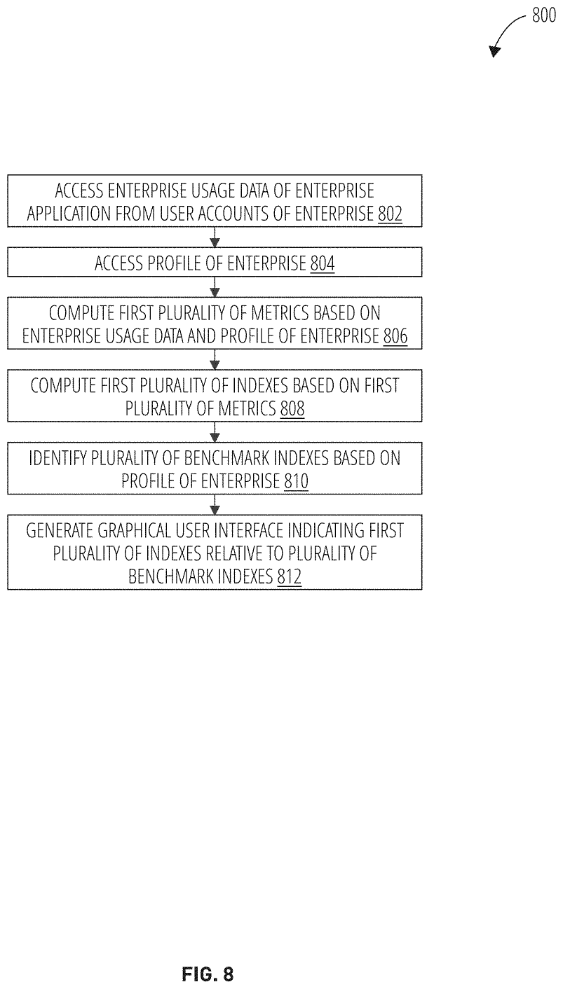

FIG. 8 illustrates a routine in accordance with one embodiment. In block 802, routine 800 accesses enterprise usage data of an enterprise application from user accounts of an enterprise. In block 804, routine 800 accesses a profile of the enterprise. In block 806, routine 800 computes a first plurality of metrics based on the enterprise usage data and the profile of the enterprise. In block 808, routine 800 computes a first plurality of indexes based on the first plurality of metrics. In block 810, routine 800 identifies a plurality of benchmark indexes based on the profile of the enterprise. In block 812, routine 800 generates a graphical user interface indicating the first plurality of indexes relative to the plurality of benchmark indexes.

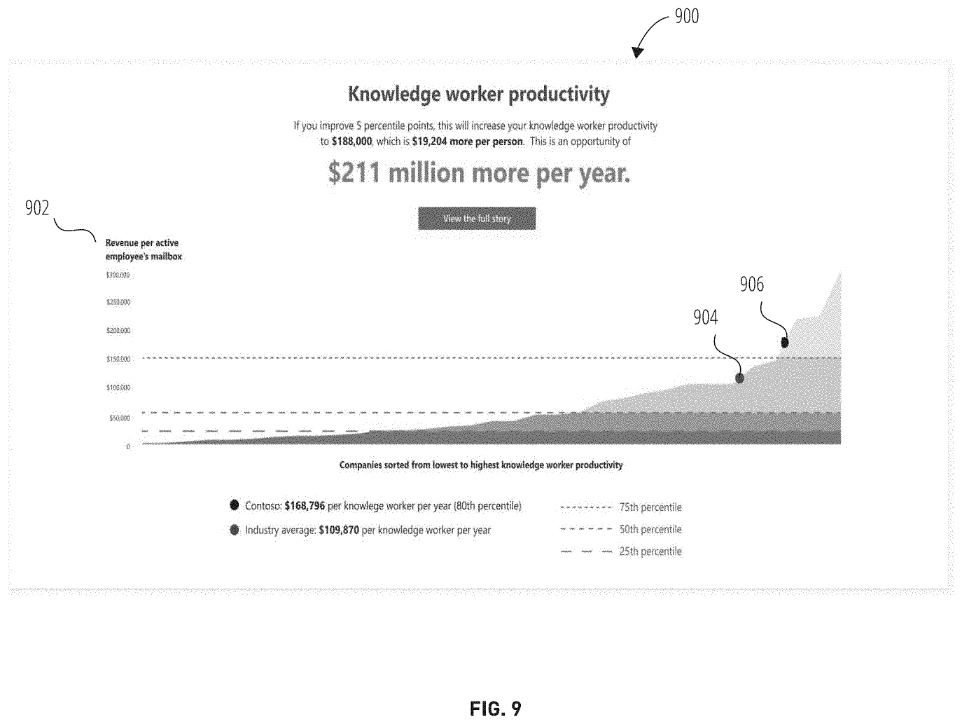

FIG. 9 illustrates an example of a graphical user interface 900 of a knowledge worker productivity analysis in accordance with one example embodiment. The y axis 902 represents the revenue per active employee's mailbox. The dot 904 represent an enterprise. The dot 906 represents an industry average.

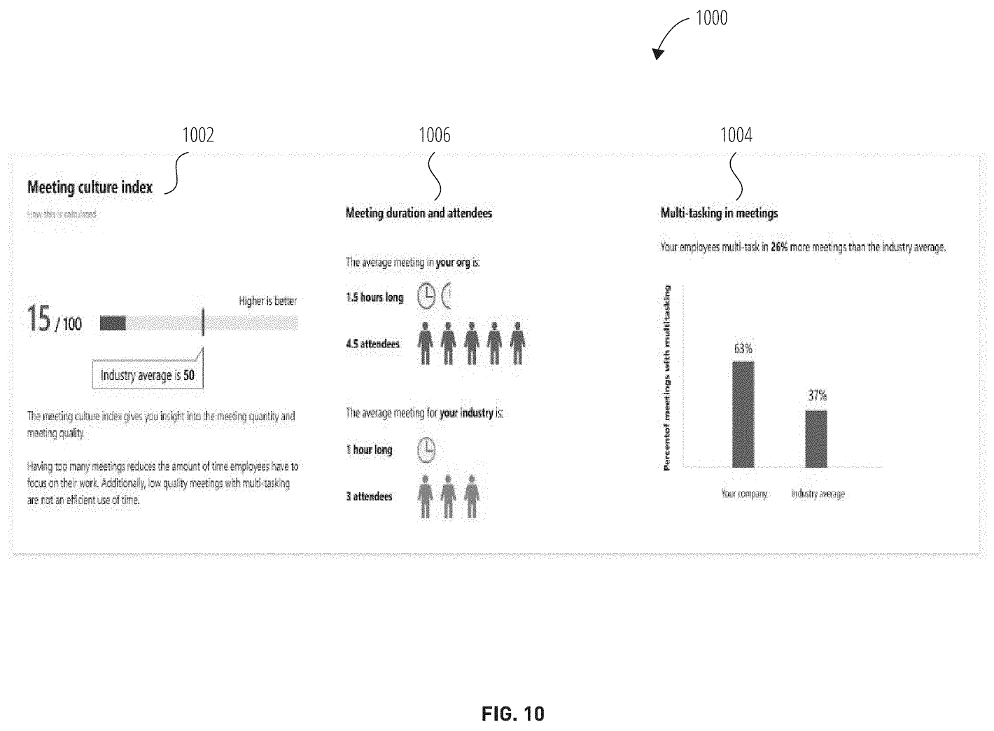

FIG. 10 illustrates an example of a graphical user interface 1000 of a meeting culture index in accordance with one example embodiment. In one example, the graphical user interface 1000 includes a meeting culture index 1002, a meeting duration and attendees' graph 1006, and a multi-tasking in meetings graph 1004.

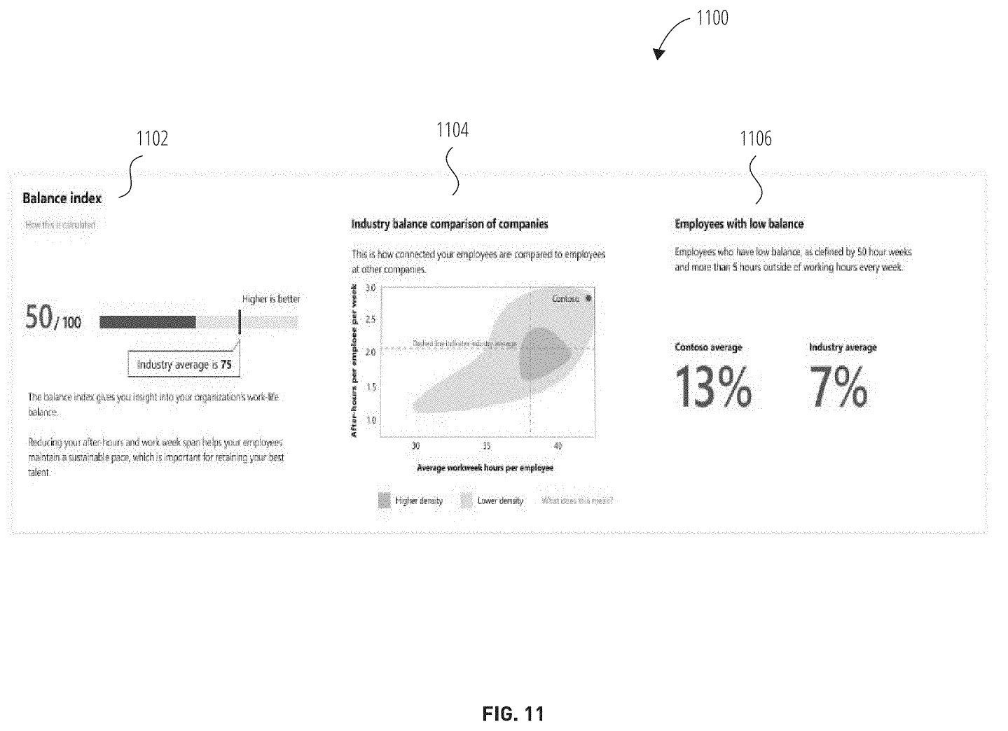

FIG. 11 illustrates an example of a graphical user interface 1100 of a balance index in accordance with one example embodiment. In one example, the graphical user interface 1100 includes a balance index 1102, an industry balance comparison of companies graph 1104, and an employees with low balance graph 1106.

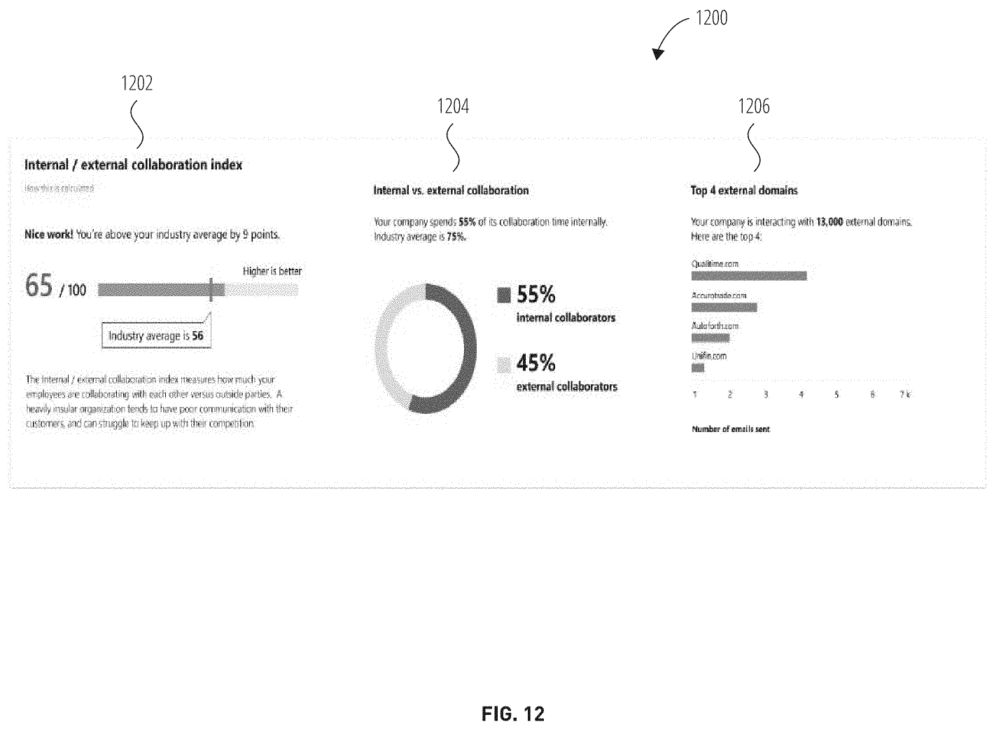

FIG. 12 illustrates an example of a graphical user interface 1200 of a collaboration index in accordance with one example embodiment. In one example, the graphical user interface 1200 includes an internal/external collaboration index 1202, an internal vs. external collaboration graph 1204, a top 4 external domains graph 1206.

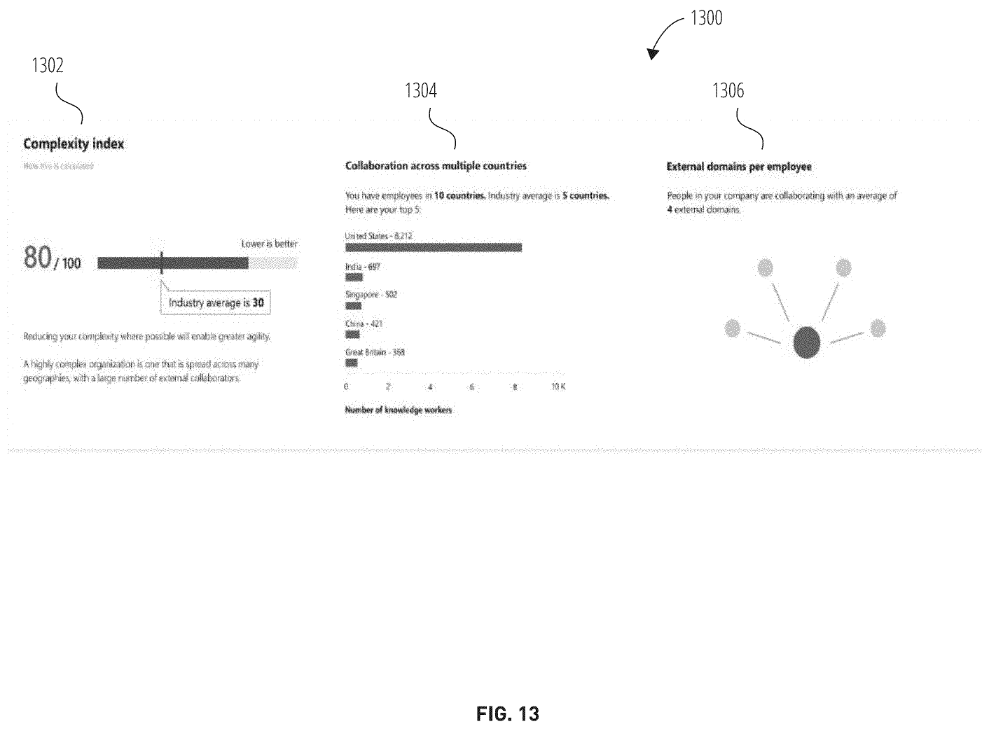

FIG. 13 illustrates an example of a graphical user interface 1300 of a complexity index in accordance with one example embodiment. In one example, the graphical user interface 1300 includes a complexity index 1302, a collaboration across multiple countries graph 1304, and an external domains per employee graph 1306.

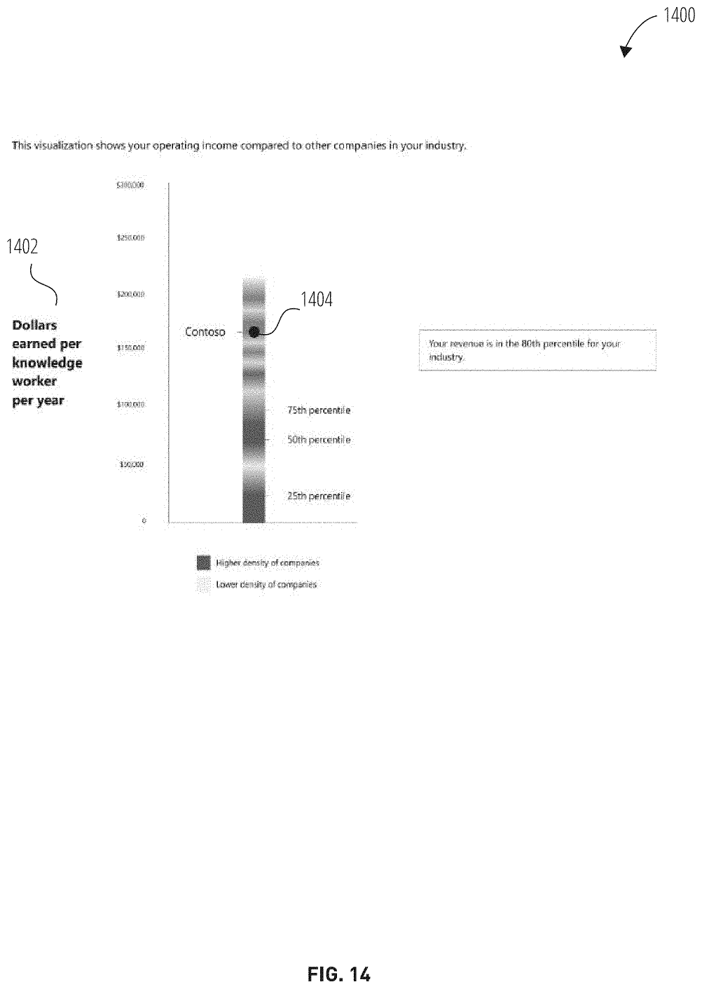

FIG. 14 illustrates an example of a graph 1400 of operating income in accordance with one example embodiment. The y axis 1402 of the graph 1400 represents dollars earned per knowledge worker per year. The dot 1404 represents an example enterprise.

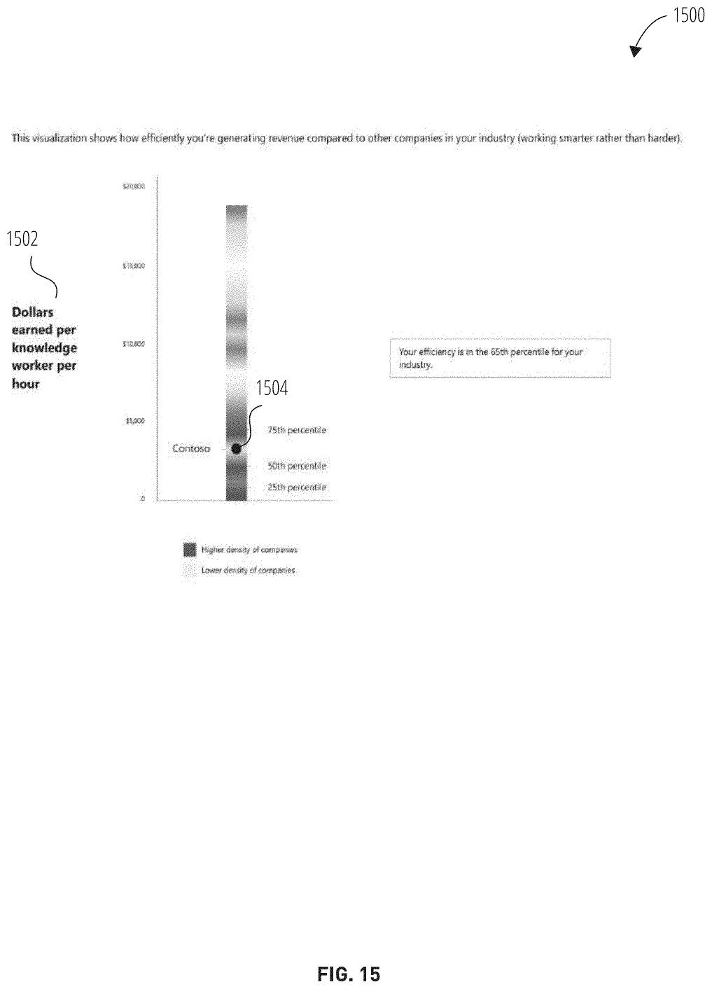

FIG. 15 illustrates an example of a graph 1500 of revenue income in accordance with one example embodiment. The y axis 1502 of the graph 1500 represents dollars earned per knowledge worker per hour. The dot 1504 represents an example enterprise.

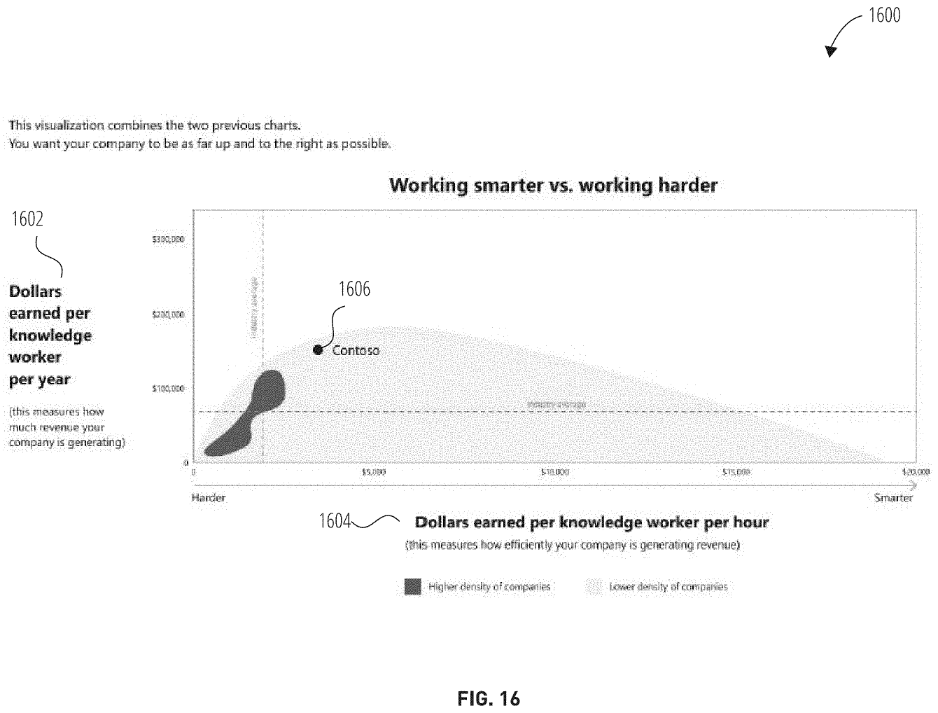

FIG. 16 illustrates an example of a graph 1600 of working performance in accordance with one example embodiment. The y axis 1602 of the graph 1600 represents dollars earned per knowledge worker per year. The x axis 1604 of the graph 1600 represents dollars earned per knowledge worker per hour. The dot 1606 represents an example enterprise.

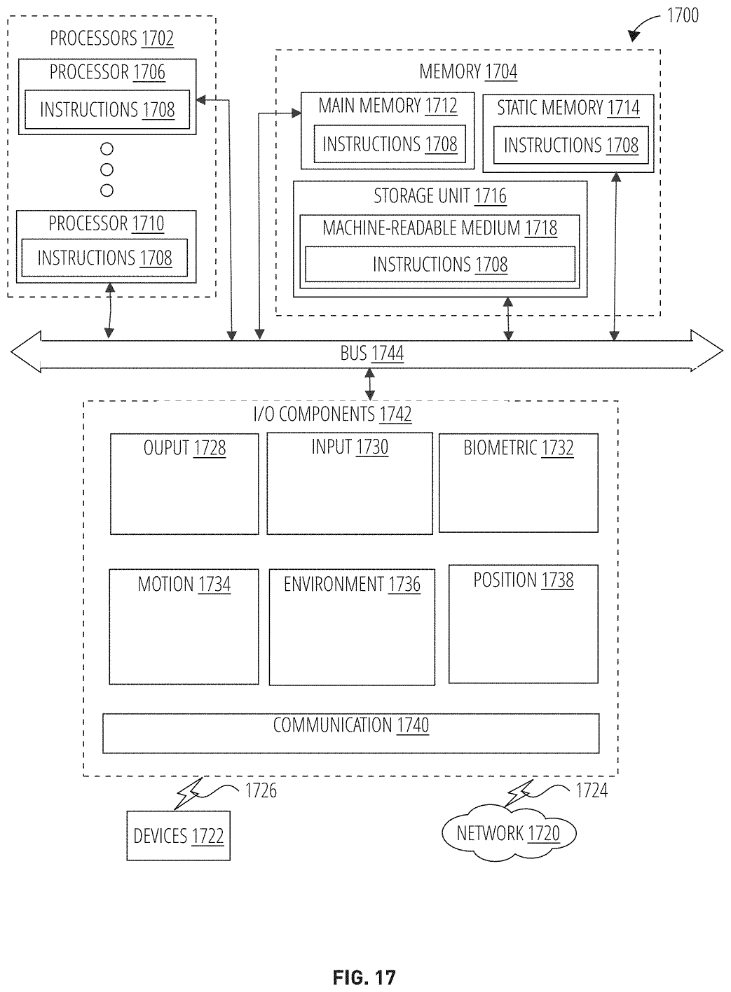

FIG. 17 is a diagrammatic representation of the machine 1700 within which instructions 1708 (e.g., software, a program, an application, an applet, an app, or other executable code) for causing the machine 1700 to perform any one or more of the methodologies discussed herein may be executed. For example, the instructions 1708 may cause the machine 1700 to execute any one or more of the methods described herein. The instructions 1708 transform the general, non-programmed machine 1700 into a particular machine 1700 programmed to carry out the described and illustrated functions in the manner described. The machine 1700 may operate as a standalone device or may be coupled (e.g., networked) to other machines. In a networked deployment, the machine 1700 may operate in the capacity of a server machine or a client machine in a server-client network environment, or as a peer machine in a peer-to-peer (or distributed) network environment. The machine 1700 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1708, sequentially or otherwise, that specify actions to be taken by the machine 1700. Further, while only a single machine 1700 is illustrated, the term “machine” shall also be taken to include a collection of machines that individually or jointly execute the instructions 1708 to perform any one or more of the methodologies discussed herein.

The machine 1700 may include processors 1702, memory 1704, and I/O components 1742, which may be configured to communicate with each other via a bus 1744. In an example embodiment, the processors 1702 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1706 and a processor 1710 that execute the instructions 1708. The term “processor” is intended to include multi-core processors that may comprise two or more independent processors (sometimes referred to as “cores”) that may execute instructions contemporaneously. Although FIG. 17 shows multiple processors 1702, the machine 1700 may include a single processor with a single core, a single processor with multiple cores (e.g., a multi-core processor), multiple processors with a single core, multiple processors with multiples cores, or any combination thereof.

The memory 1704 includes a main memory 1712, a static memory 1714, and a storage unit 1716, both accessible to the processors 1702 via the bus 1744. The main memory 1704, the static memory 1714, and storage unit 1716 store the instructions 1708 embodying any one or more of the methodologies or functions described herein. The instructions 1708 may also reside, completely or partially, within the main memory 1712, within the static memory 1714, within machine-readable medium 1718 within the storage unit 1716, within at least one of the processors 1702 (e.g., within the processor's cache memory), or any suitable combination thereof, during execution thereof by the machine 1700.

The I/O components 1742 may include a wide variety of components to receive input, provide output, produce output, transmit information, exchange information, capture measurements, and so on. The specific I/O components 1742 that are included in a particular machine will depend on the type of machine. For example, portable machines such as mobile phones may include a touch input device or other such input mechanisms, while a headless server machine will likely not include such a touch input device. It will be appreciated that the I/O components 1742 may include many other components that are not shown in FIG. 17. In various example embodiments, the I/O components 1742 may include output components 1728 and input components 1730. The output components 1728 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1730 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1742 may include biometric components 1732, motion components 1734, environmental components 1736, or position components 1738, among a wide array of other components. For example, the biometric components 1732 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1734 include acceleration sensor components (e.g., accelerometer), gravitation sensor components, rotation sensor components (e.g., gyroscope), and so forth. The environmental components 1736 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1738 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1742 further include communication components 1740 operable to couple the machine 1700 to a network 1720 or devices 1722 via a coupling 1724 and a coupling 1726, respectively. For example, the communication components 1740 may include a network interface component or another suitable device to interface with the network 1720. In further examples, the communication components 1740 may include wired communication components, wireless communication components, cellular communication components, Near Field Communication (NFC) components, Bluetooth® components (e.g., Bluetooth® Low Energy), WiFi® components, and other communication components to provide communication via other modalities. The devices 1722 may be another machine or any of a wide variety of peripheral devices (e.g., a peripheral device coupled via a USB).

Moreover, the communication components 1740 may detect identifiers or include components operable to detect identifiers. For example, the communication components 1740 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1740, such as location via Internet Protocol (IP) geolocation, location via Wi-Fi® signal triangulation, location via detecting an NFC beacon signal that may indicate a particular location, and so forth.

The various memories (e.g., memory 1704, main memory 1712, static memory 1714, and/or memory of the processors 1702) and/or storage unit 1716 may store one or more sets of instructions and data structures (e.g., software) embodying or used by any one or more of the methodologies or functions described herein. These instructions (e.g., the instructions 1708), when executed by processors 1702, cause various operations to implement the disclosed embodiments.

The instructions 1708 may be transmitted or received over the network 1720, using a transmission medium, via a network interface device (e.g., a network interface component included in the communication components 1740) and using any one of a number of well-known transfer protocols (e.g., hypertext transfer protocol (HTTP)). Similarly, the instructions 1708 may be transmitted or received using a transmission medium via the coupling 1726 (e.g., a peer-to-peer coupling) to the devices 1722.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

### EXAMPLES

Example 1 is a computer-implemented method comprising: accessing enterprise usage data of an enterprise application from user accounts of an enterprise; accessing a profile of the enterprise; computing a first plurality of metrics based on the enterprise usage data and the profile of the enterprise; computing a first plurality of indexes based on the first plurality of metrics; identifying a plurality of benchmark indexes based on the profile of the enterprise; and generating a graphical user interface indicating the first plurality of indexes relative to the plurality of benchmark indexes.

Example 2 is the computer-implemented method of example 1, further comprising: accessing aggregate usage data of the enterprise application from a plurality of enterprises; computing a second plurality of metrics based on the aggregate usage data; computing a second plurality of indexes based on the second plurality of metrics; and identifying a third plurality of indexes from the second plurality of indexes based on the profile of the enterprise, the profile of the enterprise corresponding to a profile of the enterprises associated with the third plurality of indexes, the plurality of benchmark indexes comprising the third plurality of indexes.

Example 3 is the computer-implemented method of example 2, further comprising: accessing a third-party database that comprises periodically updated data related to the plurality of enterprises; and computing the second plurality of metrics based on the periodically updated data.

Example 4 is the computer-implemented method of example 2, further comprising: filtering the aggregate usage data based on a preset minimum metric and a preset maximum metric; and computing the second plurality of metrics based on the filtered aggregate data.

Example 5 is the computer-implemented method of claim 2, further comprising: receiving a request to generate an enterprise analysis from the enterprise; identifying an industry classification and a size classification of the enterprise; and identifying the third plurality of indexes based on the industry classification and the size classification of the enterprise.

Example 6 is the computer-implemented method of claim 1, further comprising: generating a recommendation based on a comparison of the first plurality of indexes with the plurality of benchmark indexes for the enterprise.

Example 7 is the computer-implemented method of claim 1, wherein the recommendation indicates suggested parameters of a feature of the enterprise application, the feature configured to increase or decrease an index of the first plurality of indexes.

Example 8 is the computer-implemented method of claim 1, wherein the first plurality of indexes comprises: a knowledge worker productivity index; a meeting culture index; a work-life balance index; a collaboration index; and an enterprise complexity index.

Example 9 is the computer-implemented method of claim 8, further comprising: generating a first recommendation based on the knowledge worker productivity index; generating a second recommendation based on the meeting culture index; generating a third recommendation based on the work-life balance index; generating a fourth recommendation based on the collaboration index; generating a fifth recommendation based on the enterprise complexity index; presenting a first graphical user interface element configured to indicate the first recommendation; presenting a second graphical user interface element configured to indicate the second recommendation; presenting a third graphical user interface element configured to indicate the third recommendation; presenting a fourth graphical user interface element configured to indicate the fourth recommendation; and presenting a fifth graphical user interface element configured to indicate the fifth recommendation.

Example 10 is the computer-implemented method of claim 9, further comprising: receiving a selection of one of the first, second, third, fourth, and fifth recommendation; and generating a call function corresponding to a feature of the enterprise application, the feature associated with the selected recommendation.

What is claimed is:

1. A computer-implemented method comprising:
accessing enterprise usage data of an enterprise application from user accounts of an enterprise;
accessing a profile of the enterprise;
computing a first plurality of metrics based on the enterprise usage data and the profile of the enterprise;
computing a first plurality of indexes based on the first plurality of metrics;
identifying a plurality of benchmark indexes based on the profile of the enterprise; and
generating a graphical user interface indicating the first plurality of indexes relative to the plurality of benchmark indexes.

2. The computer-implemented method of claim 1, further comprising:
accessing aggregate usage data of the enterprise application from a plurality of enterprises;
computing a second plurality of metrics based on the aggregate usage data;
computing a second plurality of indexes based on the second plurality of metrics; and
identifying a third plurality of indexes from the second plurality of indexes based on the profile of the enterprise, the profile of the enterprise corresponding to a profile of the enterprises associated with the third plurality of indexes; the plurality of benchmark indexes comprising the third plurality of indexes.

3. The computer-implemented method of claim 2, further comprising:
accessing a third-party database that comprises periodically updated data related to the plurality of enterprises; and
computing the second plurality of metrics based on the periodically updated data.

4. The computer-implemented method of claim 2, further comprising:
filtering the aggregate usage data based on a preset minimum metric and a preset maximum metric; and
computing the second plurality of metrics based on the filtered aggregate data.

5. The computer-implemented method of claim 2, further comprising:
receiving a request to generate an enterprise analysis from the enterprise;
identifying an industry classification and a size classification of the enterprise; and
identifying the third plurality of indexes based on the industry classification and the size classification of the enterprise.

6. The computer-implemented method of claim 1, further comprising:
generating a recommendation based on a comparison of the first plurality of indexes with the plurality of benchmark indexes for the enterprise.

7. The computer-implemented method of claim 1, wherein the recommendation indicates suggested parameters of a feature of the enterprise application; the feature configured to increase or decrease an index of the first plurality of indexes.

8. The computer-implemented method of claim 1, wherein the first plurality of indexes comprises:
a knowledge worker productivity index;
a meeting culture index;
a work-life balance index;
a collaboration index; and
an enterprise complexity index.

9. The computer-implemented method of claim 8, further comprising:
generating a first recommendation based on the knowledge worker productivity index;
generating a second recommendation based on the meeting culture index;
generating a third recommendation based on the work-life balance index;
generating a fourth recommendation based on the collaboration index;
generating a fifth recommendation based on the enterprise complexity index;
presenting a first graphical user interface element configured to indicate the first recommendation;
presenting a second graphical user interface element configured to indicate the second recommendation;
presenting a third graphical user interface element configured to indicate the third recommendation;
presenting a fourth graphical user interface element configured to indicate the fourth recommendation; and
presenting a fifth graphical user interface element configured to indicate the fifth recommendation.

10. The computer-implemented method of claim 9, further comprising:
receiving a selection of one of the first, second, third, fourth, and fifth recommendation; and
generating a call function corresponding to a feature of the enterprise application, the feature associated with the selected recommendation.

11. A computing apparatus, the computing apparatus comprising:
a processor; and
a memory storing instructions that, when executed by the processor, configure the apparatus to:
access enterprise usage data of an enterprise application from user accounts of an enterprise;
access a profile of the enterprise;
compute a first plurality of metrics based on the enterprise usage data and the profile of the enterprise;
compute a first plurality of indexes based on the first plurality of metrics;
identify a plurality of benchmark indexes based on the profile of the enterprise; and
generate a graphical user interface indicating the first plurality of indexes relative to the plurality of benchmark indexes.

12. The computing apparatus of claim 11, wherein the instructions further configure the apparatus to:
access aggregate usage data of the enterprise application from a plurality of enterprises;
compute a second plurality of metrics based on the aggregate usage data;
compute a second plurality of indexes based on the second plurality of metrics; and
identify a third plurality of indexes from the second plurality of indexes based on the profile of the enterprise, the profile of the enterprise corresponding to a profile of the enterprises associated with the third plurality of indexes, the plurality of benchmark indexes comprising the third plurality of indexes.

13. The computing apparatus of claim 12, wherein the instructions further configure the apparatus to:
access a third-party database that comprises periodically updated data related to the plurality of enterprises; and
compute the second plurality of metrics based on the periodically updated data.

14. The computing apparatus of claim 12, wherein the instructions further configure the apparatus to:
filter the aggregate usage data based on a preset minimum metric and a preset maximum metric; and
compute the second plurality of metrics based on the filtered aggregate data.

15. The computing apparatus of claim 12, wherein the instructions further configure the apparatus to:
receive a request to generate an enterprise analysis from the enterprise;
identify an industry classification and a size classification of the enterprise; and
identify the third plurality of indexes based on the industry classification and the size classification of the enterprise.

16. The computing apparatus of claim 11, wherein the instructions further configure the apparatus to:
generate a recommendation based on a comparison of the first plurality of indexes with the plurality of benchmark indexes for the enterprise.

17. The computing apparatus of claim 11, wherein the recommendation indicates suggested parameters of a feature of the enterprise application, the feature configured to increase or decrease an index of the first plurality of indexes.

18. The computing apparatus of claim 11, wherein the first plurality of indexes comprises:
a knowledge worker productivity index;
a meeting culture index;
a work-life balance index;
a collaboration index; and
an enterprise complexity index.

19. The computing apparatus of claim 18, wherein the instructions further configure the apparatus to:
generate a first recommendation based on the knowledge worker productivity index;
generate a second recommendation based on the meeting culture index;
generate a third recommendation based on the work-life balance index;
generate a fourth recommendation based on the collaboration index;
generate a fifth recommendation based on the enterprise complexity index;
present a first graphical user interface element configured to indicate the first recommendation;
present a second graphical user interface element configured to indicate the second recommendation;
present a third graphical user interface element configured to indicate the third recommendation;
present a fourth graphical user interface element configured to indicate the fourth recommendation; and
present a fifth graphical user interface element configured to indicate the fifth recommendation.

20. A non-transitory computer-readable storage medium, the computer-readable storage medium including instructions that when executed by a computer, cause the computer to:
access enterprise usage data of an enterprise application from user accounts of an enterprise;
access a profile of the enterprise;
compute a first plurality of metrics based on the enterprise usage data and the profile of the enterprise;
compute a first plurality of indexes based on the first plurality of metrics;
identify a plurality of benchmark indexes based on the profile of the enterprise; and
generate a graphical user interface indicating the first plurality of indexes relative to the plurality of benchmark indexes.
